(19) United States
(12) Patent Application Publication
(10) Pub. No.: US 2010/0178824 A1
(43) Pub. Date: Jul. 15, 2010

(54) METHOD OF PRODUCING THIN LAYERS OF A SILICON, AND THIN SILICON

(75) Inventors: Kurt Stark, Weilersbach (DE); Werner Schmidt, Strullendorf (DE); Walter Gunter, Bovenden (DE)

Correspondence Address: GIFFORD, KRASS, SPRINKLE,ANDERSON & CITKOWSKI, P.C, PO BOX 7021, TROY, MI, 48007-7021, US

(73) Assignee: Huhtamaki Forchheim Zweigniederiassung der Huhtamaki Deutschland GmbH & Co. KG, fORCHHEIM (DE)

(21) Appl. No.: 12/305,793

(22) PCT Filed: Jun. 18, 2007
(86) PCT No.: PCT/EP2007/056040

§ 371 Date: Mar. 3, 2009

(30) Foreign Application Priority Data
Jun. 21, 2006 (DE) 10 2006 028 901.3

(51) Int. Cl. B32B 27/08; B29C 47/06; B29C 69/00; C08G 77/00; B32B 27/10

(52) U.S. Cl. 442/62; 264/176.1; 264/210.1; 528/10; 428/452; 428/451; 428/337

(57) ABSTRACT

The invention relates to a method for producing thin layers (3) of a silicon that can be subjected to plastic treatment, whereby the silicon layer (3) is extruded, and to the thin silicon layer produced by said method.

### FIELD OF THE INVENTION

The invention relates to a method of producing thin layers of a plastically processible silicon and to the thin silicon layer produced in accordance with this method.

### BACKGROUND OF THE INVENTION

The most diverse silicon coatings, which can be used thinly and in space-saving manner, are known, but in that case all have the disadvantage of having to be expensively applied to a carrier in an extra working step. In addition, the problem often exists that subsequently applied silicon coatings have only poor adhesion to the respective carrier and can unintentionally detach there.

### SUMMARY OF THE INVENTION

It is the object of the invention to propose a method of producing thin layers of a silicon, which can be executed in a single and simple working step and in which the produced silicon layers produced firmly and securely adhere to the respective carriers.

According to the invention this object is fulfilled in that the silicon layer is extruded.

In that case it has proved extremely advantageous if the silicon layer is extruded onto a carrier layer.

According to the invention it has also proved very advantageous if the carrier layer is fed after extrusion of the silicon layer.

A further very advantageous refinement of the invention is also present when the silicon layer is covered by a cover layer.

The silicon layer is protected by the cover layer against damage.

It has then also proved very advantageous if the cover layer is fed after the extrusion of the silicon layer.

In addition, it has proved extremely advantageous if the cover layer is extruded together with the silicon layer.

The cover layer is thereby produced in a single working step together with the silicon layer.

A further very advantageous refinement of the invention also resides in applying an adhesive agent between carrier layer and silicon layer.

Equally, it has proved very advantageous if an adhesive agent is introduced between the cover layer and the silicon layer.

A good connection between the layers is thereby ensured.

It is extremely advantageous if the adhesive agent is extruded together with the silicon layer.

Equally, it is extremely advantageous if the adhesive agent is extruded together with the cover layer.

A further very advantageous refinement is also present when the adhesive agent is applied to the already extruded silicon layer.

Equally, it is very advantageous if the adhesive agent is applied to the already extruded cover layer or the carrier layer.

A further very advantageous refinement of the invention also resides in co-extruding an adhesive agent, which is provided between silicon layer and carrier layer and/or cover layer, together with other layers.

A multi-layer composite can thereby be produced very quickly and economically.

Similarly, it has proved extremely advantageous in accordance with the invention if the composite of carrier layer and silicon layer is stretched.

As a result, on the one hand the properties of the silicon layer are changed and on the other hand the thickness of the silicon layer is reduced.

In that case it has also proved extremely advantageous if the composite of carrier layer, silicon layer and cover layer is stretched.

A possible bursting open or tearing of the silicon layer during the stretching process is thereby effectively avoided. In addition, the silicon layer is also protected after the stretching process.

According to the invention it has also proved very advantageous if at least the carrier layer and/or the cover layer is removed after the extrusion and/or after the stretching.

Thus, a foil siliconised on one side is produced, or, however, also a pure silicon layer.

According to the invention it is also very advantageous if the finished silicon layer is wound up.

The finished silicon layer can thereby be stored and transported particularly easily.

In that case it has proved very advantageous if a cover layer or carrier layer is provided between two strata of the silicon layer.

Adhesion of two strata of the silicon layer to one another is thereby avoided.

A silicon layer—which very advantageously is thinly extruded in accordance with a development—produced in accordance with a method according to the invention is present if a silicon, particularly a silicon organocopolymer or a silicon elastomer or the like, which is thermoplastically processible by common methods, is provided.

A thermoplastically processible silicon can be extruded particularly satisfactorily.

Equally, it has proved very advantageous if a fleece, non-woven material, fabric material, particularly a textile layer, or a paper or the like is provided as carrier layer.

Further, very interesting possibilities of use thereby result.

It has then proved very advantageous if a thermoplastic material is provided as carrier layer and/or cover layer, particularly a thermoplastic plastics film as cover layer.

Equally, it is very advantageous if polyethylene, particularly LDPE or LLDPE, is provided as thermoplastic material.

According to a further embodiment of the invention it has also proved very advantageous if polypropylene, particularly polypropylene homopolymers and polypropylene copolymers, is provided as thermoplastic material.

It is also very advantageous if a blend of different materials is provided as carrier layer and/or cover layer.

Thermoplastic materials are particularly suitable, by virtue of their properties, as carrier layer and/or cover layer.

A very advantageous development of the invention is present if ethylene acrylate copolymers, ethylene vinylacetate copolymers, acid copolymers, polymers with acid anhydride functions, particularly with unsaturated acid anhydrides, particularly polyethylene and polypropylene provided with maleic acid anhydride, ionomers, polymers with hydroxyl groups, particularly polyvinylalcohols or polyvinylalcohols containing ethylene (EVOH), copolymerisates of organic monomers with monomers containing hydroxyl groups, particularly hydroxyl ethylacrylate or hydroxyl propylacrylate, or non-functional polymers grafted with functional monomers, particularly polymers grafted with OH functional monomers, are used as adhesive agent.

In that case it is similarly very advantageous if the adhesive agent consists of blends or batches, which at least in part contain ethylene acrylate copolymers, ethylene vinylacetate copolymer, acid copolymers, polymers with acid anhydride functions, particularly polyethylene and polypropylene provided with acid anhydrides, ionomers, polymers with hydroxyl groups, particularly polyvinylalcohols or polyvinylalcohols containing ethylene (EVOH), copolymerisates of organic monomers with monomers containing hydroxyl groups, particularly hydroxy ethylacrylate or hydroxy propylacrylate, and/or non-functional polymers grafted with functional monomers, particularly polymers grafted with OH functional monomers.

In addition, it has proved very advantageous if ethylene vinylacetate copolymers are provided as adhesive agent, wherein the copolymer proportions are preferably greater than 5%.

Through this adhesive agent it is possible to set the cohesion between the silicon layer and the other layers within wide limits.

According to a further embodiment of the invention it has proved very advantageous if the carrier layer prior to the stretching has a thickness between 0.1 and 3,000 microns, particularly between 1 and 500 microns, preferably between 10 and 200 microns.

According to the invention it has also proved very advantageous if the cover layer prior to the straightening has a thickness between 0.1 and 3,000 microns, particularly between 1 and 500 microns, preferably between 10 and 200 microns.

Similarly, it is extremely advantageous if the thermoplastically processible silicon has a thickness of 0.1 and 3,000 microns, particularly between 1 and 70, particularly between 1 to 30 microns, very particularly between 2 and 20, microns.

A further very advantageous embodiment of the invention is also to be seen in that the thermoplastically processible silicon has a proportion of a silicon component which lies between 0.1 and 99.9% and is preferably greater than 90%.

The silicon component is substantially responsible for the release properties of the thermoplastically processible silicon. Good release characteristics are ensured by the large proportion of the silicon component.

Equally, according to the invention it is also very advantageous if the thermoplastically processible silicon has a proportion of a silicon component which lies between 0.1 and 99.9% and is preferably equal to or less than 60%.

Notwithstanding the relatively low silicon proportion, satisfactory release characteristics are achieved. Since silicon is relatively expensive to produce, a substantial cost saving is thereby, however, also achieved.

Moreover, it has proved very advantageous if the thermoplastically processible silicon has a separating force relative to adhesives, particularly relative to pressure-sensitive adhesives, between 1 and 700 cN/cm, preferably between 2 and 100 cN/cm.

A further field of use of the thermoplastically processible material as a release material is thereby guaranteed.

It is also very advantageous if the thermoplastically processible silicon has a melt viscosity between 1 and 1,000,000, particularly between 35,000 and 45,000, Pas.

The thermoplastically processible silicon can thereby be extruded very satisfactorily.

Equally, it is also very advantageous if the melt viscosity is measured at 180° C.

According to the invention it has proved extremely advantageous if the melt viscosity is between 1 and 1,000 Pas at 1800° C.

With low melt viscosities of that kind the silicon can be very easily applied as a hot-melt coating to a substrate.

Moreover, it has proved very advantageous if the melt viscosity is greater than 1,000 Pas at 180° C.

If the silicon compound or the silicon is present in high viscosities of that kind, this allows particularly good extrusion coatings.

According to the invention it has also proved very advantageous if the thermoplastically processible silicon has a Shore hardness between 10 and 100, particularly between 50 and 60.

A further very advantageous embodiment of the invention also resides in the adhesive force reduction according to FINAT 11 of a pressure-sensitive adhesive due to the thermoplastically processible silicon is less than 50%, preferably less than 30%, particularly less than 10%.

The adhesive force of a pressure-sensitive adhesive is thus influenced as little as possible in storage.

It has also proved very advantageous if the thickness of the thermoplastically processible silicon layer after straightening is between 0.1 and 400 microns, particularly between 0.1 and 50 microns, preferably between 1 and 5 microns.

### BRIEF DESCRIPTION OF THE DRAWINGS

The invention is explained in the following by way of several exemplifying embodiments, in which;

FIG. 1 shows a two-layer co-extrudate according to the invention, which is connected with a fleece carrier layer,

FIG. 2 shows a four-layer co-extrudate according to the invention, which is connected with a paper carrier layer and

FIG. 3 shows packaging which is formed from a co-extrudate according to the invention.

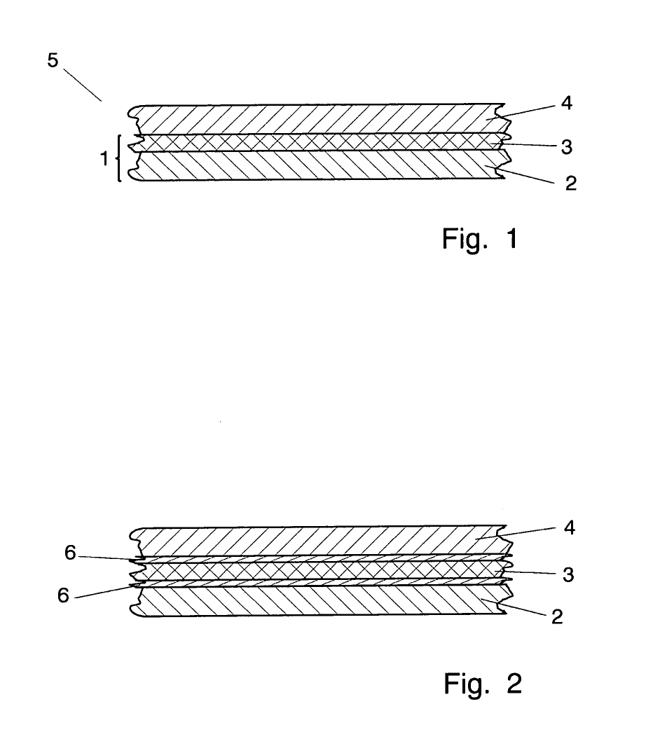

### DETAILED DESCRIPTION OF THE PREFERRED EMBODIMENTS

In a first example a two-layer co-extrudate 1 is extruded from a nozzle. This co-extrudate 1 consists of a cover layer 2 of a thermoplastic material and a silicon layer 3, which follows thereon, of a thermoplastically processible material. An overall composite 5 is created from this co-extrudate 1 by feed of a carrier layer 4 of a non-woven material, which is similarly made from a thermoplastic material and which follows the silicon.

The thermoplastic material can be a polyethylene, for example an LDPE or an LLDPE, a polypropylene or the like a blend of different materials.

After the extrusion and/or after the assembly of the overall composite 5 the composite can be stretched in longitudinal and/or transverse direction, whereby on the one hand the strength characteristics of the individual layers are improved and on the other hand the layer thicknesses are reduced. In the extrusion the cover layer 2 can have a thickness between 1 and 500 microns. The silicon layer 3 can have a thickness in the range between 5 and 30 microns. These thicknesses are significantly reduced by the stretching, whereby silicon layers 3 in a thickness of up to 0.1 microns or even less are achievable.

The silicon layer 3 is stabilised during the stretching process by the carrier layer 4 and the cover layer 2. In particular, the silicon layer 3 is prevented from forming cracks or entirely tearing apart.

Apart from the stretching process the cover layer 2 or, however, also the carrier layer 4 can—if desired and intended—be removed.

It is also conceivable for the carrier layer 4 to be made of a different material, such as, for example, a textile, a paper or also, for example, a metal. In that case it is also conceivable to form the carrier layer 4 from, for example, glass-fibres or Kevlar fibres. The silicon layer 3 can be extruded, together with the cover layer 2, onto this carrier layer or be subsequently applied by laminating.

However, it is also conceivable to provide an adhesive agent 6 between the silicon layer and the cover layer or the carrier layer 4, as is illustrated in FIG. 2.

The adhesion force between the individual layers can be set within wide ranges by the adhesive agent 6. Ethylene acrylate copolymers, ethylene vinylacetate copolymers, acid copolymers, polymers with acid anhydride functions, particularly polyethylene and polypropylene provided with acid anhydrides, ionomers, polymers with hydroxyl groups, particularly polyvinylalcohols or polyvinylalcohols containing ethylene (EVOH), copolymerisates of organic monomers with monomers containing hydroxyl groups, particularly hydroxy ethylacrylate or hydroxy propylacrylate, or non-functional polymers grafted with functional monomers, particularly polymers grafted with OH functional monomers, are primarily used as adhesive agent, as well as blends of these substances also with further substances. The adhesive agent 6 can be co-extruded either together with a cover layer 2 or with the silicon layer 3. In addition, a subsequent application of the adhesive agent layer 6 is conceivable.

It is conceivable that a 4-micron adhesive agent coating 6 and a 4-micron silicon coating 3 are extruded onto a carrier layer 4 consisting of a 16 g/m² polypropylene fleece.

However, it is also conceivable that in addition to the carrier layer 4 also the cover layer 3 is provided as a feed web and fed directly after the extrusion or laminated on later.

Such a composite is particularly suitable for producing packagings to be filled with adhesive or sticky substances.

Thus, it is conceivable to use the overall composite 5 as a wrapping packaging for blocks or the like of, for example, pressure-sensitive adhesives. However, it is also conceivable to use the overall composite 5 for packaging of hygiene articles or other at least partly adhesive or sticky articles or substances. The overall composite 5 can also be used for lining containers or wrappings. Moreover, with appropriate selection of the carrier layer it is also conceivable for the overall composite 5 to be deep-drawn.

The overall composite 5 is stretched during deep-drawing.

It is also conceivable that only a part of the overall composite 5 is used for the deep-drawing or packaging process.

Thus, for example, the cover layer 2 of the co-extrudate 1 may have been removed before the rest of the overall composite 5 is applied to, for example, a thick-layer film of polypropylene. This thick-layer film is subsequently deep-drawn together with the silicon layer 3. The remaining cover layer 2 in that case prevents, even in stretching, an undesired bursting open of the silicon layer 3. After the deep-drawing process or shortly before filling the container with the goods to be packaged, the remaining carrier layer 3 can then in addition be removed. Damage of the silicon layer 3 is thus prevented during transport of the container.

However, it is also conceivable for the overall composite 5 to also be employed for other purposes of use. Thus, for example, the overall composite 5 can be the base material for production of labels, hygiene packaging, protective foils against environmental influences, removable protective foils, window intermediate layers in safety glass, window panes or the like. Additional layers necessary for these applications are either fed subsequently to the overall composite 5 or extruded at the same time together with the layers of the coextrudate 1.

It is conceivable, particularly in the use of the overall composite 5 for hygienic packagings, for the cover layer 2 to be provided with a filler such as, for example, chalk.

It is also conceivable that, for example, a co-extrudate 1 produced in a blow-moulding method and with a thickness of the cover layer between 100 and 300 microns, an adhesive agent layer with a thickness between 10 and 20 microns and an extruded silicon layer 3 with a thickness between 8 and 15 microns is covered in such a manner that the thickness of the cover layer 2 after the stretching is between 30 and 70 microns. In that case the silicon layer 3 is reduced to a thickness of up to 0.1 microns. At the same time the stiffness and strength of the composite 5 are significantly increased.

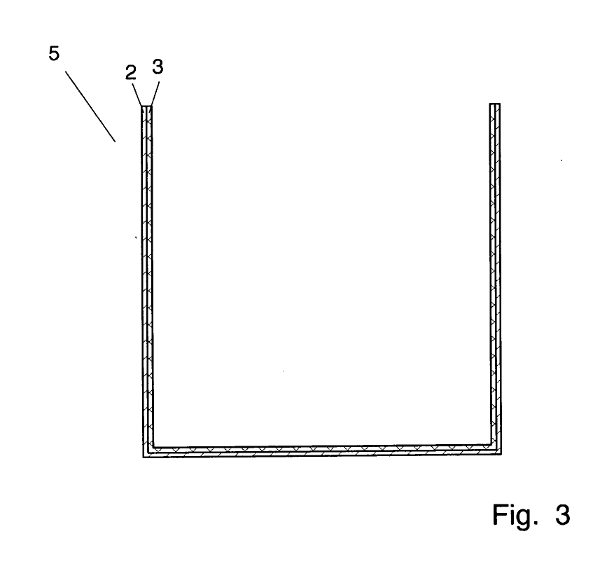

A packaging material 7 for a sanitary article (not illustrated), which is made from the composite according to the invention, is indicated in FIG. 3.

It is also conceivable for the composite according to the invention to be used for producing, covering or lining an article provided with a silicon layer, particularly packaging or a vessel, which then, for example, is prepared for reception of pressure-sensitive adhesives.

In that case, however, it is also conceivable that the carrier layer or cover layer faces away from the base material and is then deep-drawn together with the base material to form a container. The composite of carrier layer, silicon layer and cover layer can also be applied together to a base material and then deep-drawn together with the base material to form a container. In addition, the carrier layer or the cover layer can be removed after production of the container.

Through the connection of the silicon layer with the carrier layer a tearing of the silicon layer after the deep-drawing or stretching is prevented. This effect is further reinforced by the cover layer. In addition, the cover layer prevents possible damage of the silicon layer during production or during transport of an unfilled container produced therefrom.

The silicon layer according to the invention and also the composite according to the invention can form a highly transparent, preferably weather-stable, protective coating for an article. In addition, the silicon layer or the composite can represent a dirt-repelling protective layer for the article, whereby an article or the like can be protected against many environmental influences.

It is also conceivable that the silicon layer or the composite is used as a protective layer for particularly smooth surfaces. In that case the silicon layer or the composite can be held on particularly smooth surfaces by adhesion, whereby uses of the silicon layer or the composite as removable and/or exchangeable protective layers are possible.

Moreover, it is also conceivable to use the silicon layer as a separating layer for any surface structures, whereby, for example, uses of the silicon layer or the composite possibly in conjunction with further layers, which have the task of separating several layers of an article, are conceivable.

It is also conceivable that the silicon layer or the composite finds use in the most diverse forms in hygiene applications, particularly in hygiene packaging materials or the like, whereby a very simple and economic production of such packaging materials or the like is made possible.

It is also conceivable that the silicon layer or also the composite is used as an intermediate layer between several strata of a window pane, whereby inter alia safety panes with an intermediate layer with the silicon layer or the composite according to the invention can be produced in the most diverse forms of stamping for the most diverse requirements. In that case the silicon layer or the composite can be connected with further layers and form, together with these layers, a window pane or the like.

The production of panes, replacement panes, flexible emergency panes or similar is also thereby made possible in a single working step.

1. Method of producing thin layers (3) of a plastically processible silicon, characterized in that the silicon layer (3) is extruded.

2. Method according to claim 1, characterized in that the silicon layer (3) is extruded onto a carrier layer (4).

3. Method according to claim 1, characterized in that the carrier layer (4) is fed after extrusion of the silicon layer (3).

4. Method according to claim 3, characterized in that the silicon layer (3) is covered by a cover layer (2).

5. Method according to claim 4, characterized in that the cover layer (2) is fed after the extrusion of the silicon layer (3).

6. Method according to claim 4, characterized in that the cover layer (2) is extruded together with the silicon layer (3).

7. Method according to claim 2, characterized in that an adhesive agent (6) is introduced between carrier layer (4) and silicon layer (3).

8. Method according to claim 4, characterized in that an adhesive agent (6) is introduced between the cover layer (2) and the silicon layer (3).

9. Method according to claim 8, characterized in that the adhesive agent (6) is extruded together with the silicon layer (3).

10. Method according to claim 7, characterized in that the adhesive agent (6) is extruded together with the cover layer (2).

11. Method according to claim 8, characterized in that the adhesive agent (6) is applied to the already extruded silicon layer (3).

12. Method according to claim 8, characterized in that the adhesive agent (6) is applied to the carrier layer (4).

13. (canceled)

14. Method according to claim 2, characterized in that the composite of carrier layer (4) and silicon layer (3) is stretched.

15. Method according to claim 4, characterized in that the composite of carrier layer (4), silicon layer (3) and cover layer (2) is stretched.

16. Method according to claim 4, characterized in that at least the carrier layer (4) and/or the cover layer (2) is or are removed after the extrusion and/or after the stretching.

17. Method according to claim 1, characterized in that the finished silicon layer (3) is wound up.

18. Method according to claim 2, characterized in that a cover layer (2) is provided between two strata of the silicon layer (3).

19. Thin extruded silicon (3) comprising a silicon, particularly a silicon organocopolymer or a silicon elastomer or the like, which is thermoplastically processible by common methods.

20. Thin extruded silicon (3) according to claim 19, characterized in that a fleece, a non-woven material, a fabric material, particularly a textile layer, or a paper or the like is provided as carrier layer (4).

21. Thin silicon according to claim 19, characterized in that a thermoplastic material, is provided as carrier layer (4) and a cover layer (2), particularly a thermoplastic plastics film provided as cover layer.

22. Thin silicon according to claim 21, characterized in that polyethylene, particularly LDPE or LLDPE, is provided as thermoplastic material.

23. Thin silicon according to claim 21, characterized in that polypropylene, particularly polypropylene homopolymers and polypropylene copolymers, is provided as thermoplastic material.

24. Thin silicon according to claim 21, characterized in that a blend of different materials is provided as carrier layer (4) and cover layer (2).

25. Thin silicon according to claim 24, including an adhesive agent (6) used between the carrier layer (4) and the silicon layer (3) and between the cover layer (2) and the silicon layer (3), characterized in that adhesive (6) is selected from ethylene acrylate copolymers, ethylene vinylacetate copolymers, acid copolymers, polymers with acid anhydride functions, particularly with unsaturated acid anhydrides, particularly polyethylene and polypropylene provided with maleic acid anhydride, ionomers, polymers with hydroxyl groups, particularly polyvinylalcohols or polyvinylalcohols containing ethylene (EVOH), copolymerisates of organic monomers with monomers containing hydroxyl groups, particularly hydroxy ethyl acrylate or hydroxy propylacrylate, or non-functional polymers grafted with functional monomers, particularly polymers grafted with OH functional monomers.

26. Thin silicon according to claim 19, including an adhesive agent (6) used between the carrier layer (4) and the silicon layer (3) and between the cover layer (2) and the silicon layer (3) characterized in that the adhesive agent (6) consists of blends or batches, which at least in part contain ethylene acrylate copolymers, ethylene vinylacetate copolymers, acid copolymers, polymers with acid and hydride functions, particularly polyethylene and polypropylene provided with acid anhydrides, ionomers, polymers with hydroxyl groups, particularly polyvinylalcohols or polyvinylalcohols containing ethylene (EVOH), copolymerisates of organic monomers with monomers containing hydroxyl groups, particularly hydroxy ethylacrylate or hydroxy propylacrylate, and/or non-functional polymers grafted with functional monomers, particularly polymers grafted with OH functional monomers.

27. Thin silicon according to claim 26, characterized in that ethylene vinylacetate copolymers are provided as adhesive agent (6), wherein the copolymer proportions are preferably greater than 5%.

28. Thin silicon according to claim 20, characterized in that the carrier layer (4) prior to the stretching has a thickness between 0.1 and 3,000 microns, particularly between 1 and 500 microns, preferably between 10 and 200 microns.

29. Thin silicon according to claim 21, characterized in that the cover layer (2) prior to the stretching has a thickness between 0.1 and 3,000 microns, particularly between 1 and 500 microns, preferably between 10 and 200 microns.

30. Thin silicon according to claim 19, characterized characterised in that the thermoplastically processible silicon has a thickness of 0.1 and 3,000 microns, preferably between 1 and 70, particularly between 1 to 30 microns, very particularly between 2 and 20, microns.

31. Thin silicon according to claim 19, characterized in that the thermoplastically processible silicon has a proportion of a silicon component which lies between 0.1 and 99.9% and is preferably greater than 90%.

32. Thin silicon according to claim 19, characterized in that the thermoplastically processible silicon has a proportion of a silicon component which lies between 0.1 and 99.9% and which is preferably equal to or less than 60%.

33. Thin silicon according to claim 19, characterized in that the thermoplastically processible silicon has a separating force relative to adhesives, particularly relative to pressure-sensitive adhesives, of between 1 and 700 cN/cm, preferably between 2 and 100 cN/cm.

34. Thin silicon according to claim 19, characterized in that the thermoplastically processible silicon has a melt viscosity between 1 and 1,000,000, particularly between 35,000 and 45,000, Pas.

35. Thin silicon according to claim 34, characterized in that the melt viscosity is measured at 180° C.

36. Thin silicon according to claim 35, characterized in that the melt viscosity is between 1 and 1,000 Pas at 180° C.

37. Thin silicon according to claim 35, characterized in that the melt viscosity is greater than 1,000 Pas at 180° C.

38. Thin silicon according to claim 19, characterized in that the thermoplastically processible silicon (3) has a shore hardness of between 10 and 100, particularly between 50 and 60.

39. Thin silicon according to claim 19. characterized in that the adhesive force reduction according to FINAT 11 of a pressure-sensitive adhesive due to the thermoplastically processible silicon is less than 50%, preferably less than 30%, particularly less than 10%.

40. Thin silicon according to claim 19, characterized in that the thickness of the thermoplastically processible silicon layer (3) after the stretching is between 0.1 and 400 microns, particularly between 0.1 and 50 microns, preferably between 1 and 5 microns.
